(19) United States
(12) Patent Application Publication
(10) Pub. No.: US 2010/0089374 A1
(43) Pub. Date: Apr. 15, 2010

(54) Nitrous-Oxide System with a Pair of Solenoids in Series

(76) Inventor: James Atherley, Plaeasant Grove, UT (US)

Correspondence Address: THORPE NORTH & WESTERN, LLP., P.O. Box 1219, SANDY, UT, 84091-1219, US

(21) Appl. No.: 12/251,121

(22) Filed: Oct. 14, 2008

(51) Int. Cl. F02B 23/00

(52) U.S. Cl. 123/585

(57) ABSTRACT

A nitrous-oxide system for an internal combustion engine includes a nitrous-oxide bottle containing nitrous-oxide coupled to a nitrous-oxide line. A nozzle can be coupled to the nitrous-oxide line, and operatively coupled to an engine intake. A pair of solenoids is operably coupled in series to the nitrous-oxide line between the nitrous-oxide bottle and the nozzle. The solenoids can be operable to control the flow of nitrous oxide through the nitrous oxide line to an engine intake. A control switch is operatively coupled to the pair of solenoids to selectively activate at least one of the pair of solenoids to close the at least one solenoid and stop nitrous oxide from flowing through the nitrous oxide line.

### RELATED APPLICATIONS

This application is related to U.S. patent application Ser. No. 11/386,055, filed Oct. 12, 2006, and U.S. patent application Ser. No. ______, filed ______ (TNW Docket Number 00051-35175), and U.S. patent application Ser. No. ______, filed ______ (TNW Docket Number 00051-35174).

### BACKGROUND OF THE INVENTION

1. Field of the Invention

The present invention relates generally to a nitrous-oxide system for a vehicle, namely a motorized vehicle with an internal combustion engine.

2. Related Art

Nitrous-oxide systems (NOS) or nitrous-oxide (N2O) chargers have been developed to increase engine performance. Such systems inject compressed and/or liquid nitrous-oxide into the combustion chamber of an engine during the fuel intake stroke of the combustion chamber piston to provide more oxygen for combustion. More oxygen in the combustion chamber means that more fuel can also be injected during the intake stroke. The increase in fuel and oxygen during the combustion cycle results in greater energy being transferred to the piston which increases the stroke cycle of the piston. The increased stroke cycle of the pistons is then transferred to the cam shaft which ultimately results in an increase in horse power of the engine.

Compressed nitrous-oxide also vaporizes and cools when it is released from the pressure vessel in which it is stored. This provides a cooling effect on the intake air. Reducing the intake air temperature increases the air's density, and provides even more oxygen to the engine. For the engine to operate properly, the nitrous-oxide and fuel mixture ratio must be correct.

Many such nitrous oxide systems use solenoid valves to control the flow of nitrous oxide through a nitrous oxide line and into the engine. Unfortunately, these solenoid valves can stick in the open position or fail to fully close. Thus, such valves can inadvertently deplete a nitrous oxide from a nitrous oxide tank.

### SUMMARY OF THE INVENTION

The inventor of the present invention has recognized that it would be advantageous to develop a nitrous-oxide system for an internal combustion engine that has improved control and reduces the risks of a solenoid valve sticking open.

The present invention provides for a nitrous-oxide system for an internal combustion engine. The nitrous oxide system can include a nitrous-oxide bottle containing nitrous-oxide. A nitrous-oxide line can be coupled to the nitrous-oxide bottle. A nozzle can be coupled to the nitrous-oxide line, and operatively coupled to an engine intake. A pair of solenoids can be operably coupled in series to the nitrous-oxide line between the nitrous-oxide bottle and the nozzle. The solenoids can be operable to control the flow of nitrous oxide through the nitrous oxide line to an engine intake.

The present invention also provides for a method for controlling the flow of nitrous oxide through a nitrous oxide line to an engine intake of an internal combustion engine including opening a pair of solenoids fluidly coupled in series to a nitrous oxide line to allow nitrous oxide to flow through the nitrous oxide line to the engine intake from a nitrous oxide bottle. At least one of the pair of solenoids can be closed to stop the flow of nitrous oxide through the nitrous oxide line.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1a is a schematic view of a nitrous-oxide system in accordance with an embodiment of the present invention;

FIG. 1b is a schematic view of a housing with a pair of solenoids coupled to a nitrous oxide line of the nitrous oxide system of FIG. 1a;

FIG. 2 is a schematic perspective view of a nitrous-oxide bottle of the nitrous-oxide system of FIG. 1 coupled to an engine with a carburetor;

FIG. 3 is a schematic view of a nitrous oxide system in accordance with another embodiment of the present invention coupled to an engine with electronic fuel injection; and

FIG. 4 is a schematic view of the nitrous-oxide system of FIG. 1 coupled to an engine of a vehicle.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention generally provides for a nitrous-oxide system for selectively increasing the performance of an internal combustion fueled engine (such as gasoline, diesel, liquid petroleum or compressed natural gas fueled) and/or providing a power boost to such an engine. Snowmobiles, All-Terrain Vehicles (ATVs), motorcycles, automobiles, semi-trucks, riding lawnmowers and tractors are examples of vehicles that can benefit from the use of nitrous-oxide systems. The nitrous-oxide system includes a nitrous-oxide source, such as a pressure vessel or bottle filled with nitrous-oxide. Delivery lines can deliver nitrous-oxide from the bottle to a nozzle. The nozzle can inject the nitrous-oxide into an intake of the engine, such as an air box, where the nitrous will move with the intake air to combine with the vehicle fuel. Valves for both nitrous-oxide and extra fuel can be disposed in a single box that can be disposed in an engine compartment. The nitrous oxide valve or valve system can include a pair of solenoids. Each solenoid can independently open and close so as to restrict flow of nitrous oxide through the solenoid. The pair of solenoids can be operated simultaneously to open or close both solenoids in unison. In this way, the pair of solenoids can act as a single valve that controls the flow of nitrous oxide. Additionally, if one of the pair of solenoids becomes stuck in the open position, the other solenoid can still close to shut off the flow of nitrous oxide.

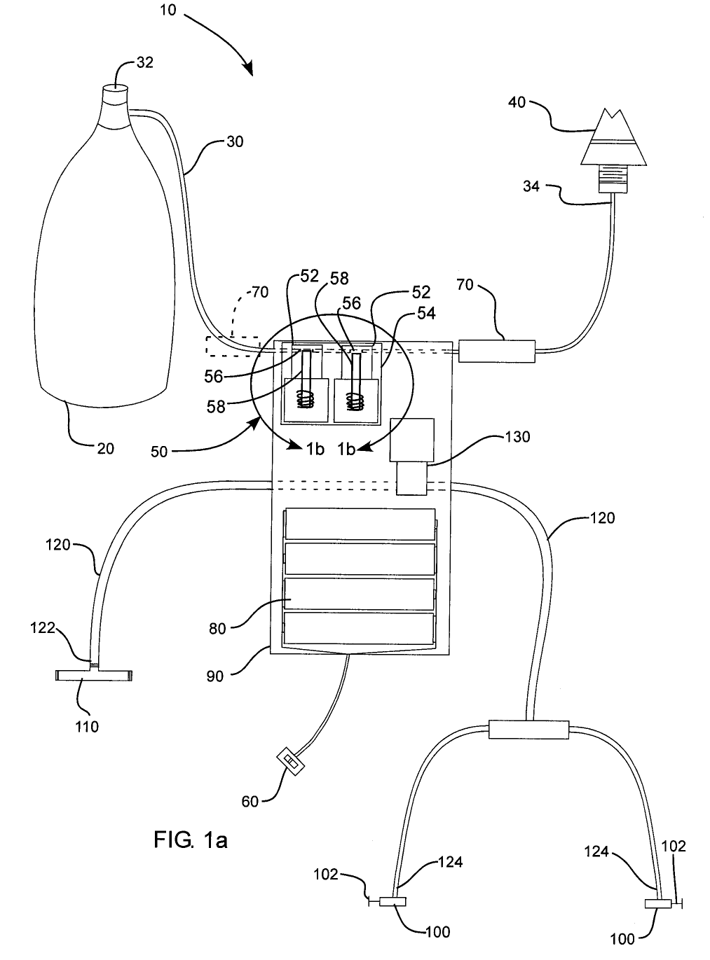

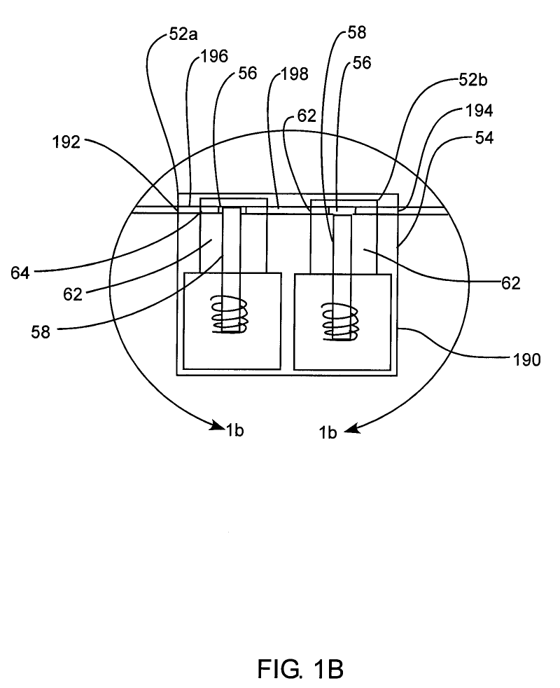

As illustrated in FIGS. 1a-1b, a nitrous-oxide system 10 in accordance with an embodiment of the present invention is shown. The nitrous-oxide system has a nitrous-oxide source, such as a bottle reservoir 20. The nitrous-oxide bottle 20 is configured to contain pressurized nitrous-oxide. In one aspect, the nitrous-oxide bottle 20 can contain pressurized liquid nitrous-oxide.

A nitrous-oxide line 30 can have a proximal end 32 coupled to the nitrous-oxide bottle. A nozzle 40 can be coupled to the distal end 34 of the nitrous-oxide line. The nozzle 40 can be operatively coupled to an engine intake such as an air-box, or the like. The term “air-box” is used broadly herein to refer to any engine structure upstream of the cylinder(s). For example, the air-box can be a filtered air box, a carburetor, fuel injector, and the like. The term “nozzle” is used broadly herein to refer to means for delivering the nitrous oxide from the nitrous oxide line to the engine intake. For example, the nozzle can be a nozzle, an opening in the nitrous oxide line, a port, a valve, and the like. The term “line” is used broadly herein to refer to any device that can deliver a fluid from a source to a destination. For example, a line can be a hollow tube, a channel, a hose, a pipe, a path, and the like.

A nitrous-oxide valve 50 can be coupled to the nitrous-oxide line 30 between the nitrous-oxide bottle 20 and the nozzle 40. The nitrous-oxide valve 50 can control release of the nitrous-oxide from the bottle to the nozzle. A control switch 60 can be operatively or electrically coupled to the nitrous-oxide valve 50. The control switch 60 can be mounted on the vehicle, such as by a throttle, to be actuated by a user. Thus, when the user actuates the control switch 60, the nitrous-oxide valve 50 opens and allows nitrous-oxide from the bottle to the nozzle, and thus the engine. A power source 80 can be coupled to the valve 50 via the control switch 60.

The nozzle can be disposed on the intake side of the engine. Coupling the nozzle 40 to an engine intake such as an air box, carburetor inlet, or carburetor outlet allows the nitrous-oxide to be injected into the engine ahead of or in combination with the fuel. Advantageously, injecting nitrous-oxide ahead of fuel reduces the chances that too much fuel will be sent to the engine causing the engine to bog down. Instead, in the present invention, the nitrous-oxide can be drawn into the carburetor or fuel injector with the air and mixed with the fuel according to the settings of the carburetor or fuel injector. Alternatively, the nitrous oxide can be introduced into the engine after the fuel is mixed by placing the nozzle downstream from the carburetor.

The nitrous-oxide bottle 20 can be mounted on structure of the vehicle. The structure of the vehicle can include a bulkhead, belly pan, hood, side panels steering column and the like. It will be appreciated that the nitrous-oxide bottle can be mounted anywhere there is sufficient space, and where the bottle will not interfere with engine operation.

The nitrous-oxide valve 50 can control the flow of nitrous-oxide from the nitrous oxide bottle 20 through the nitrous-oxide line 30 to the nozzle 40. In one aspect the nitrous-oxide valve 50 can be a solenoid valve. The nitrous-oxide valve 50 can also be a flow control valve, a gate valve, a ball valve, a pilot valve, a proportional valve, a globe valve, a check valve, a needle valve, and a stopcock valve.

In another aspect, the nitrous oxide valve, indicated generally at 50 can include a pair of solenoids 52. The pair of solenoids 52 can be operably coupled in series to the nitrous-oxide line 30 between the nitrous-oxide bottle 20 and the nozzle 40. Each of the solenoids 52 can be opened to allow nitrous oxide to flow through the solenoid, and either or both can be closed to stop the flow of nitrous oxide through the solenoid. Each of the solenoids 52 can be opened or closed independently from the other solenoid such that one solenoid can be opened while the other is closed. Additionally, each of the solenoids 52 can be opened or closed together and substantially simultaneously so that the pair of solenoids can be operated in unison. With both of the solenoids 52 open, nitrous oxide can flow through the nitrous oxide line 30. In this way, the valve 50 is operable to control the flow of nitrous oxide between the bottle 20 and the nozzle 40 through the nitrous oxide line 30 and to an engine intake.

Each of the pair of solenoids 52 can include a plunger 58 and an orifice 56. Each of the plungers 58 can be associated with a different one of the solenoids 52 such that the plunger 58 can be insertable into or against the orifice 56 to close the orifice. In this way, the pair of solenoids 52 can include a pair of orifices 56 and a pair of plungers 58 with each of the plungers disposable against a different one of the orifices to close the orifice.

Referring to FIG. 1b, in one embodiment, each of the pair of solenoids 52 can be disposed in a housing 190 that has a nitrous oxide inlet 192 and a nitrous oxide outlet 194. A nitrous oxide channel 196 can extend between the nitrous oxide inlet and outlet. Nitrous oxide can flow through the housing 190 in the nitrous oxide channel 196. A chamber 62 disposed in each of the solenoids 52 can be fluidly coupled to the nitrous oxide channel 196 between the nitrous oxide inlet 192 and outlet 194 of the housing 190. An orifice 64 in the chamber 62 of the first solenoid 52a can be fluidly coupled to the nitrous oxide channel 196 such that nitrous oxide can flow through the orifice 64. A nitrous oxide passageway 198 can extend from the chamber 62 of the first solenoid 52a to an orifice 64 of the chamber of the second solenoid 52b. Thus, the nitrous oxide inlet 192 can be fluidly coupled by the nitrous oxide channel 196 to the orifice 64 of the chamber 64 of the first solenoid 52a, and the chamber 64 of the second solenoid 52b can be fluidly coupled to the nitrous oxide outlet 194.

In this way, nitrous oxide can flow through the nitrous oxide line 30 to the nitrous oxide inlet 192 in the housing 190. Nitrous oxide can then flow through the nitrous oxide inlet 192 to the nitrous oxide channel 196, and from the nitrous oxide channel into the orifice 64 of the chamber 62 of the first solenoid 52a. The plunger 58 of the first solenoid 52a can be opened or closed to allow the nitrous oxide to flow through the orifice 62 to the nitrous oxide passage 198 and into orifice 64 in the chamber 62 of the second solenoid 52b. The plunger 58 of the second solenoid 52b can be opened or closed to allow the nitrous oxide to flow through the orifice 64 of the chamber 62 of the second solenoid 52b through the nitrous oxide channel 196 to the nitrous oxide outlet 194 in the housing 190. The nitrous oxide can then flow from the housing 190 to the nozzle 40 in the engine intake.

Returning to FIGS. 1a-1b, it is a particular advantage of the nitrous oxide system 10 described herein that the valve 50 includes a pair of solenoids 52. It will be appreciated that solenoids can experience operational failures such that the solenoid can become stuck in the open position. Additionally, some solenoids will experience wear and tear over time such that the solenoid will not completely close. When either condition occurs nitrous oxide is allowed to continue to flow through the nitrous oxide line until the nitrous oxide in the bottle is depleted. In the first instance, with the solenoid stuck in an open position, the nitrous oxide in the bottle can be depleted very quickly and can cause the engine to maintain an unexpected, and undesirable accelerated performance throughout the depletion. Such a condition can pose serious safety issues to the user of the engine. In the second condition, where the solenoid does not close completely, the nitrous escapes in a slow bleed off referred to as weeping or hissing.

Thus, advantageously the pair of solenoids 52 of the nitrous oxide valve 50 of the present invention reduces the likelihood of inadvertently losing or depleting nitrous oxide from the bottle due to a nitrous oxide valve that is stuck open or fails to fully close because the chances of both of the pair of solenoids sticking or weeping is lower than a single solenoid valve. In this way, the solenoids 52 provide a redundant valve system having two valve gates so that if one of the gates fails the other will still function to control nitrous oxide being released from the bottle.

It will be appreciated that the pair of solenoids 52 can be contained within a common housing 54. In this way, each of the solenoids 52 together can form the nitrous oxide valve 50. In another embodiment, each of the solenoids can be contained in separate housings such that the nitrous oxide system has two nitrous oxide valves that operate together.

A battery power source 80, such as batteries, can be electrically coupled to the nitrous-oxide valve. In one aspect, the battery power source 80 can be free from transfer of electricity with the engine and free from electrical interference from the engine. Specifically, the battery power 80 source can be separate from the battery source and electrical system coupled to the engine. For example, the battery power source 80 for the nitrous-oxide system 10 can be as simple and inexpensive as a plurality of AA size batteries connected in series. Alternatively, in another aspect, the power source can utilize electricity from the vehicle electrical power system. Thus, the nitrous-oxide system 10 can have a power source 80 that is independent of the engine or vehicle power source, or a power source that is integrated with the vehicle power source.

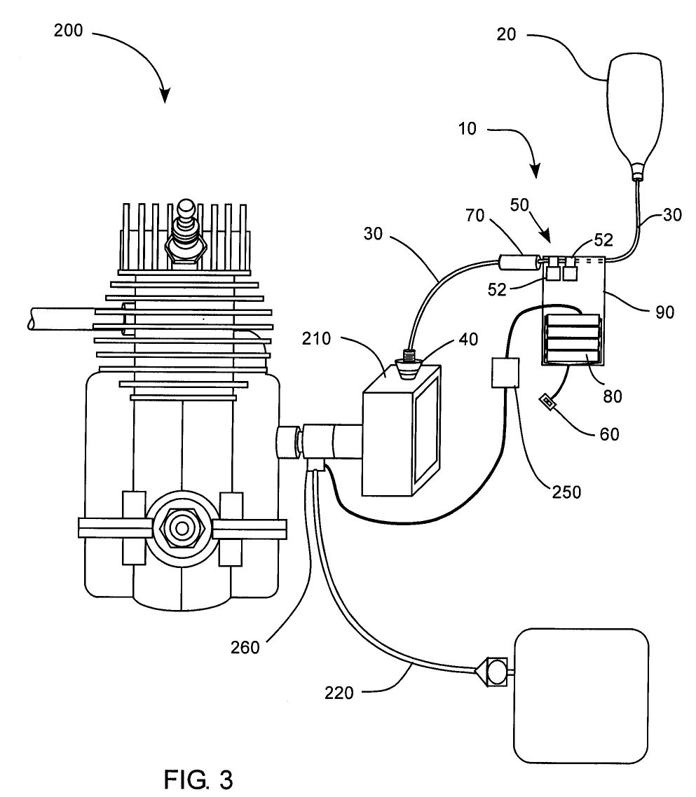

The nitrous-oxide system 10 can also have a secondary fuel line 120. The secondary fuel line 120 can be coupled to a primary fuel line 110 (FIG. 3) and can extend through the enclosure 90. The secondary fuel line 120 can provide a secondary source of fuel to the engine with respect to the primary fuel line. Alternatively, the secondary fuel line can be coupled to a secondary fuel source.

A fuel valve 130 can be operably coupled to the secondary fuel line 120 and the nitrous oxide line 30 such that the fuel valve 130 can control the flow of fuel through the secondary fuel line 120 to the engine intake.

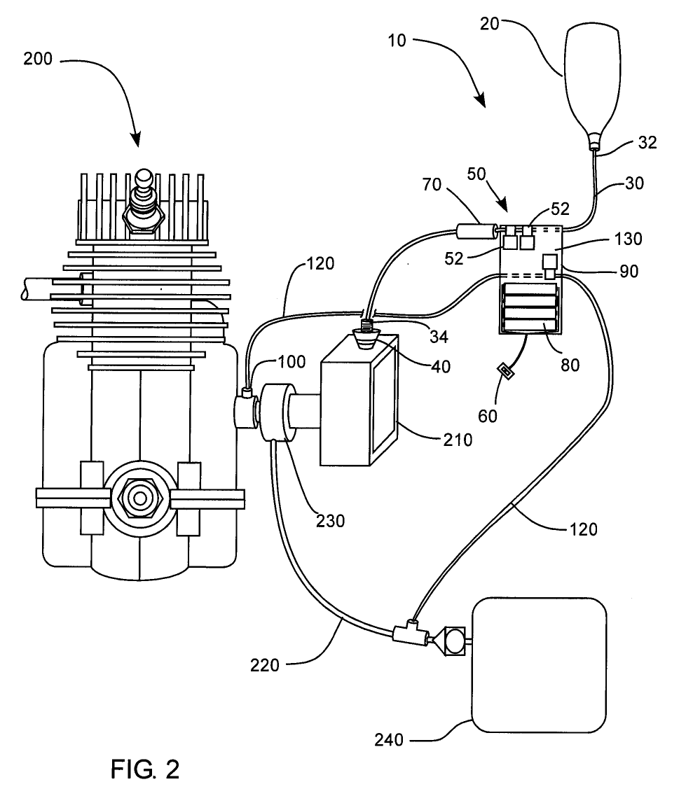

Turning now to FIG. 2, a schematic view of a nitrous-oxide system 10 coupled to an engine 200 in accordance with an embodiment of the present invention is shown. A nitrous-oxide bottle 20 containing nitrous-oxide can be coupled to the proximal end 32 of a nitrous-oxide line 30. A nozzle 40 can be coupled to the distal end 34 of the nitrous-oxide line, and disposed in an air-box 210. A nitrous-oxide valve 50 can be coupled to the nitrous-oxide line 30 to control flow of nitrous-oxide from the nitrous-oxide bottle to the nozzle. A battery power source 80 can be electrically coupled to the nitrous-oxide valve. A control switch 60 can be operatively coupled to the nitrous-oxide valve 50 or battery power source 80, to activate the nitrous-oxide valve 50.

A secondary fuel line 120 can be tapped into the engine's primary fuel line 220, and can extend to a carburetor 230, to provide a secondary source of fuel from the fuel tank 240 with respect to the primary fuel line 220 and the carburetor 230. Alternatively, the secondary fuel line can be coupled to a secondary fuel source. A fuel valve 130 can be coupled to the secondary fuel line 220 to control flow of fuel through the secondary fuel line to the carburetors 230.

As discussed above, an enclosure 90 can be disposed about the nitrous-oxide valve 50, the fuel valve 130, and the battery power source 80. Advantageously, having the valves 50 and 130 and battery power source 80 contained in an enclosure 90 allows for preassembly at the factory of the nitrous-oxide system 10. Having the nitrous-oxide system 10 preassembled reduces installation time and complexity because the user need not assemble many small parts, but instead only needs to splice into the engine fuel lines and air box. Additionally, the nitrous oxide valve, auxiliary fuel valve, batter power source, box and lines can be a kit that can be used to retrofit an existing internal combustion engine.

As shown in FIG. 3, a fuel controller 250 can be coupled to the control switch 60 and an electronic fuel injector system 260, to change the fuel injector system 260 to provide more fuel when the control switch 60 is activated. The fuel controller 250 can be external to the enclosure, or can be included inside the enclosure with the battery power source and the nitrous-oxide valve. In this way, the amount of fuel in the internal combustion engine 200 can be increased or decreased by the fuel injection system 260 in response to the amount of nitrous oxide introduced to the engine via the pair of solenoids 52. Thus, instead of an auxiliary fuel line and fuel valve, the additional fuel can be added by the fuel injection system to balance the nitrous oxide in the engine.

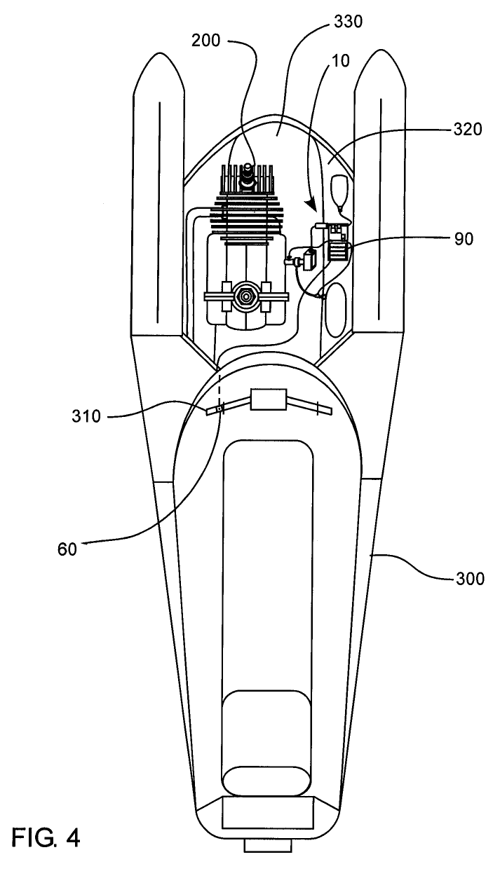

FIG. 4 illustrates the nitrous-oxide system 10 mounted to a snowmobile 300 with the enclosure 90 mounted to a side panel 320 of the snowmobile's engine compartment 330. FIG. 4 also illustrates placement of the control switch 60. The control switch 60 can be operatively coupled to the nitrous-oxide valve 50 or battery power source 80 to active the nitrous-oxide valve. The control switch 60 can be located to facilitate operation, such as on a control panel or steering mechanism 310 of the vehicle. The steering mechanism 310 can be the handlebar 310 of a snowmobile 300.

In operation, a user activates the control switch 60 when a power boost is required or desired. The control switch 60 provides power from the battery power source 80 to the nitrous-oxide valve 50 or pair of solenoids 52 causing the nitrous-oxide valve 50 or pair of solenoids 52 to open. Nitrous oxide from the nitrous oxide line 30 can flow into the auxiliary fuel valve 130 causing the fuel valve 130 to open. As the pair of solenoids 52 and fuel valve 130 opens, fuel and nitrous-oxide can flow into the engine, thereby increasing power output of the engine upon combustion. Releasing the control switch 60 can cause the fuel valve and at least one of the solenoids to close.

The present invention also provides for a method for controlling the flow of nitrous oxide through a nitrous oxide line to an engine intake of an internal combustion engine including opening a pair of solenoids fluidly coupled in series to a nitrous oxide line to allow nitrous oxide to flow through the nitrous oxide line to the engine intake from a nitrous oxide bottle. At least one of the pair of solenoids can be closed to stop the flow of nitrous oxide through the nitrous oxide line.

The method also includes closing both of the solenoids in the pair of solenoids to stop flow of nitrous oxide in the nitrous oxide line. The pressure of the nitrous-oxide can be regulated with an inline pressure regulator coupled to the nitrous-oxide line.

The method also includes coupling a nozzle to the nitrous oxide line. The nozzle can be positioned in the engine intake adjacent an inlet of a carburetor. The nozzle can be oriented to inject nitrous oxide through the inlet and directly into a throat of the carburetor.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A nitrous-oxide system for an internal combustion engine, comprising:
a) a nitrous-oxide bottle containing nitrous-oxide;
b) a nitrous-oxide line, coupled to the nitrous-oxide bottle;
c) a nozzle, coupled to the nitrous-oxide line, and operatively coupled to an engine intake;
d) a pair of solenoids, operably coupled in series to the nitrous-oxide line between the nitrous-oxide bottle and the nozzle, and operable to control the flow of nitrous oxide through the nitrous oxide line to the nozzle; and
e) a control switch, operatively coupled to the pair of solenoids to selectively activate at least one of the pair of solenoids to close the at least one solenoid and stop nitrous oxide from flowing through the nitrous oxide line.

2. A system in accordance with claim 1, wherein the pair of solenoids further includes a pair of orifices and a pair of plungers with each of the plungers disposable against a different one of the orifices to close the orifice.

3. A system in accordance with claim 1, wherein the pair of solenoids further includes a pair of orifices operably coupled in series to the nitrous oxide line.

4. A system in accordance with claim 1, further comprising:
a) a secondary fuel line, couplable to a primary fuel line extending between a tank and a carburetor, the secondary fuel line extendable to the carburetor, to provide a secondary source of fuel with respect to the primary fuel line; and
b) a fuel valve, coupled to the secondary fuel line and the nitrous oxide line to control flow of fuel through the secondary fuel line to the carburetors.

5. A system in accordance with claim 1, further comprising:
a fuel controller, coupled to the control switch and configured to be coupled to an electronic fuel injector system, to change the fuel injector system to provide more fuel when the control switch is activated.

6. A system in accordance with claim 1, further comprising:
an internal combustion engine operatively coupled to the engine intake, operable to receive a mixture of fuel and air from the engine intake.

7. A system in accordance with claim 1, wherein the pair of solenoids further comprises:
a) a housing sized and shaped to contain the pair of solenoids, and having a nitrous oxide inlet fluidly coupled to the nitrous oxide line and a nitrous oxide outlet;
b) a nitrous oxide channel extending through the housing between the nitrous oxide inlet and the nitrous oxide outlet;
c) a chamber of a first solenoid having an orifice extending through the chamber, the orifice being fluidly coupled to the nitrous oxide channel and configured to receive nitrous oxide therefrom; and
d) a nitrous oxide passage extending between the chamber of the first solenoid to an orifice of a chamber of a second solenoid, the orifice being fluidly coupled to the nitrous oxide passage and configured to receive nitrous oxide therefrom and direct nitrous oxide to the nitrous oxide outlet of the housing.

8. A method for controlling flow of nitrous oxide through a nitrous oxide line to an engine intake of an internal combustion engine, comprising:
a) opening a pair of solenoids fluidly coupled in series to a nitrous oxide line to allow nitrous oxide to flow through the nitrous oxide line to the engine intake from a nitrous oxide bottle; and
b) closing at least one of the pair of solenoids to stop flow of nitrous oxide through the nitrous oxide line.

9. A method in accordance with claim 8, further comprising:
opening the pair of solenoids simultaneously to allow nitrous oxide to flow through the nitrous oxide line.

10. A method in accordance with claim 8, further comprising:
closing both of the solenoids in the pair of solenoids to stop flow of nitrous oxide in the nitrous oxide line.

11. A method in accordance with claim 8, further comprising:
a) operating a control switch to open the pair of solenoids; and
b) operating the control switch to close the pair of solenoids.

12. A nitrous-oxide system for an internal combustion engine, comprising:
a) a nitrous-oxide bottle containing nitrous-oxide;
b) a nitrous-oxide line, coupled to the nitrous-oxide bottle;
c) a nozzle, coupled to the nitrous-oxide line, and operatively coupled to an engine intake;
d) a pair of solenoids, operably coupled in series to the nitrous-oxide line between the nitrous-oxide bottle and the nozzle, and operable to control the flow of nitrous oxide through the nitrous oxide line to the nozzle, the pair of solenoids further comprising:
i) a housing sized and shaped to contain the pair of solenoids, and having a nitrous oxide inlet fluidly coupled to the nitrous oxide line and a nitrous oxide outlet;
ii) a nitrous oxide channel extending through the housing between the nitrous oxide inlet and the nitrous oxide outlet;
iii) a chamber of a first solenoid having an orifice extending through the chamber, the orifice being fluidly coupled to the nitrous oxide channel and configured to receive nitrous oxide therefrom; and
iv) a nitrous oxide passage extending between the chamber of the first solenoid to an orifice of a chamber of a second solenoid, the orifice being fluidly coupled to the nitrous oxide passage and configured to receive nitrous oxide therefrom and direct nitrous oxide to the nitrous oxide outlet of the housing; and
e) a control switch, operatively coupled to the pair of solenoids to selectively activate at least one of the pair of solenoids to close the at least one solenoid and stop nitrous oxide from flowing through the nitrous oxide line.

13. A system in accordance with claim 12, wherein the pair of solenoids further includes a pair of plungers with each of the plungers disposable against a different one of the orifices to close the orifice.

14. A system in accordance with claim 12, further comprising:
a) a secondary fuel line, couplable to a primary fuel line extending between a tank and a carburetor, the secondary fuel line extendable to the carburetor, to provide a secondary source of fuel with respect to the primary fuel line; and
b) a fuel valve, coupled to the secondary fuel line and the nitrous oxide line to control flow of fuel through the secondary fuel line to the carburetors.

15. A system in accordance with claim 12, further comprising:
a fuel controller, coupled to the control switch and configured to be coupled to an electronic fuel injector system, to change the fuel injector system to provide more fuel when the control switch is activated.

16. A system in accordance with claim 12, further comprising:
an internal combustion engine operatively coupled to the engine intake, operable to receive a mixture of fuel and air from the engine intake.
